(19) United States
(12) Patent Application Publication
(10) Pub. No.: US 2014/0136540 A1
(43) Pub. Date: May 15, 2014

(54) QUERY DIVERSITY FROM DEMAND BASED CATEGORY DISTANCE

(71) Applicant: EBAY INC., San Jose, CA (US)

(72) Inventors: Duangmanee Putthividhya, Campbell, CA (US); Zhaohui Chen, Sunnyvale, CA (US)

(73) Assignee: eBay Inc., San Jose, CA (US)

(21) Appl. No.: 13/673,266

(22) Filed: Nov. 9, 2012

(51) Int. Cl. G06F 17/30

(52) U.S. Cl. 707/740; 707/E17.061; 707/E17.089

(57) ABSTRACT

A system and method of determining the level of diversity for a search query are described. Distances between leaf categories in a hierarchical category tree are determined using co-click counts between the leaf categories for a query. Coordinate representations of the leaf categories are determined using the distances between the leaf categories. A diversity score for the query is determined using the coordinate representations. The diversity score represents a degree of variability in what different users find relevant to the query. In some embodiments, determining distances between leaf categories comprises determining the distances using a normalization of the co-click counts that uses co-impression counts between the leaf categories for the query. In some embodiments, a manifold learning algorithm is used to determine the coordinate representations. In some embodiments, multi-dimensional scaling is used to determine the coordinate representations.

### TECHNICAL FIELD

The present application relates generally to the technical field of data processing, and, in various embodiments, to systems and methods of determining the level of ambiguity or diversity for a search query.

### BACKGROUND

Query diversity, or ambiguity, is defined as variability in what different individuals find relevant to the same search query. Ambiguous queries have been identified as the types of queries that can benefit from personalized search, where ranking results can be customized to the user's search history. In addition, when a broad or ambiguous query is issued, it may be beneficial to further solicit feedback from the user for clarification of the user's intent.

Query diversity is particularly important in e-commerce. When a user comes to an e-commerce site, the user is typically not always familiar with the kind of inventory that is on the site. For example, eBay has everything from collector coins to iPhone cases to clothing. A user who is not very familiar with the site's inventory types in a query for something he or she is looking for. However, sometimes the query results in items that are unrelated to the user's query. For example, the user could be looking for Fossil clothing and type in “Fossil” as the query, not knowing that the e-commerce site has an inventory of dinosaur fossils. As a result, the user might not be presented with the most relevant items.

### BRIEF DESCRIPTION OF THE DRAWINGS

Some embodiments of the present disclosure are illustrated by way of example and not limitation in the figures of the accompanying drawings, in which like reference numbers indicate similar elements and in which:

FIG. 1 is a block diagram depicting a network architecture of a system, according to some embodiments, having a client-server architecture configured for exchanging data over a network.

FIG. 2 is a block diagram depicting a various components of a network-based publisher, according to some embodiments.

FIG. 3 is a block diagram illustrating an example embodiment of a system that determines the level of diversity for a search query.

FIG. 4A illustrates an example embodiment of a sparse graph with leaf category nodes.

FIG. 4B illustrates an example embodiment of a dense graph with leaf category nodes.

FIG. 5A is a table illustrating an example embodiment of the top five nearest neighbors for a leaf category.

FIG. 5B is a table illustrating an example embodiment of the top five nearest neighbors for another leaf category.

FIG. 6A illustrates an example embodiment of a graph that plots eigenvalues against the number of dimensions of the coordinate representation.

FIG. 6B illustrates an example embodiment of a graph that plots residuals against the number of dimensions of the coordinate representation.

FIG. 7 is a flowchart illustrating an example embodiment of a method for determining the level of diversity for a search query.

FIG. 8 is a flowchart illustrating an example embodiment of a method for training a machine-learned ranking model.

FIG. 9 shows a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes ways of recognizing how diverse a query is. In order to better estimate query diversity, a category distance measure can be incorporated into computing a query diversity score, exploiting user behavior data and a notion of distance/similarity between two leaf categories based on frequency of co-clicks. The query diversity score can be used in training a machine-learned ranking function.

In some embodiments, distances between leaf categories in a hierarchical category tree can be determined using co-click counts between the leaf categories for a query. Coordinate representations of the leaf categories can then be determined using the distances between the leaf categories. A diversity score for the query can then be determined using the coordinate representations. The diversity score can represent a degree of variability in what different users find relevant to the query.

In some embodiments, the step of determining distances between leaf categories comprises determining the distances using a normalization of the co-click counts that uses co-impression counts between the leaf categories for the query. In some embodiments, the step of determining the coordinate representations comprises using a manifold learning algorithm. In some embodiments, the distances are geodesic distances. In some embodiments, the step of determining the distances between leaf categories comprises using Dijkstra's algorithm to determine geodesic distances between leaf categories. In some embodiments, the step of determining the coordinate representations comprises using multi-dimensional scaling. In some embodiments, the step of determining the diversity score comprises using dispersion analysis of the coordinate representations.

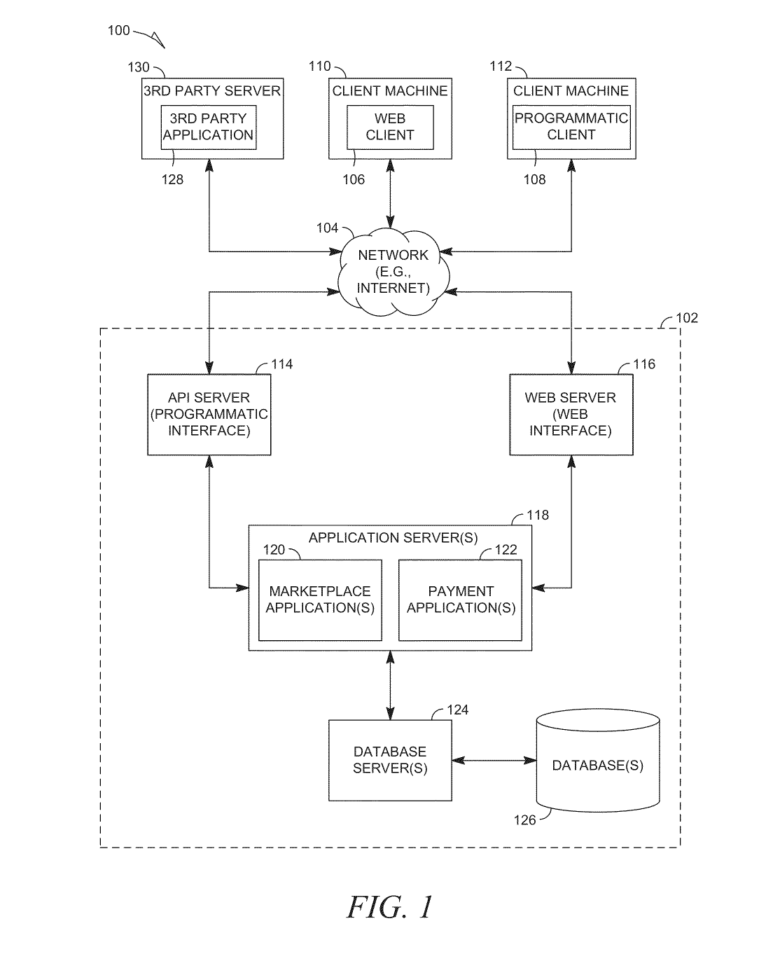

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, white the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, tier example, provide one or more promotional, marketplace, or payment functions that are supported by the relevant applications of the networked system 102.

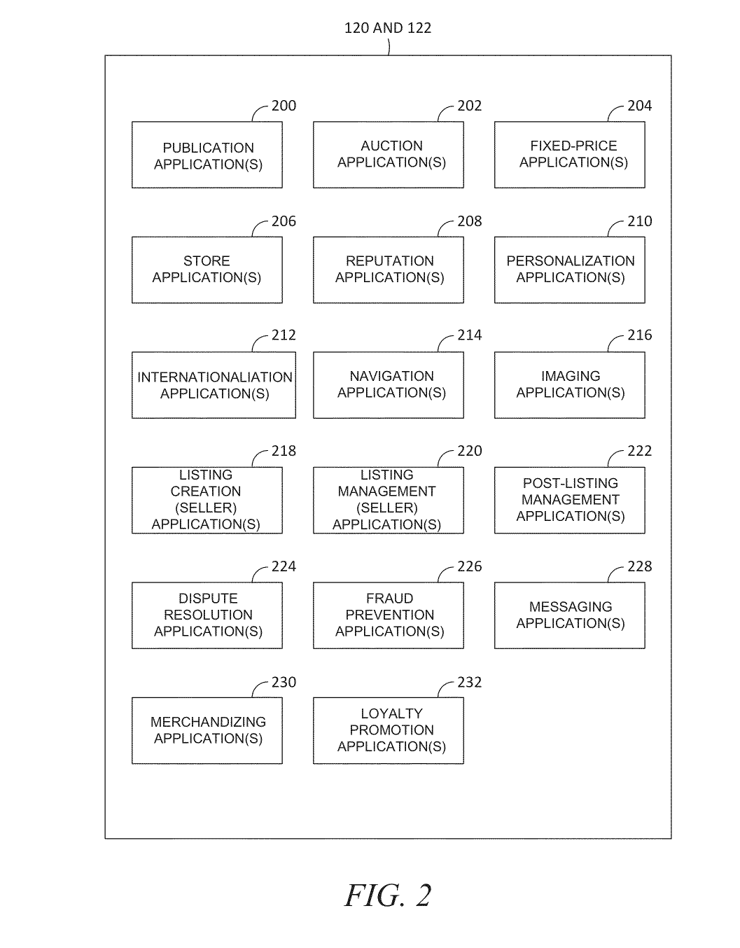

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a setter to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing an appropriate personalization application 210, create a personalized reference page at which information regarding transactions to which the user is or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

in order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable setters to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

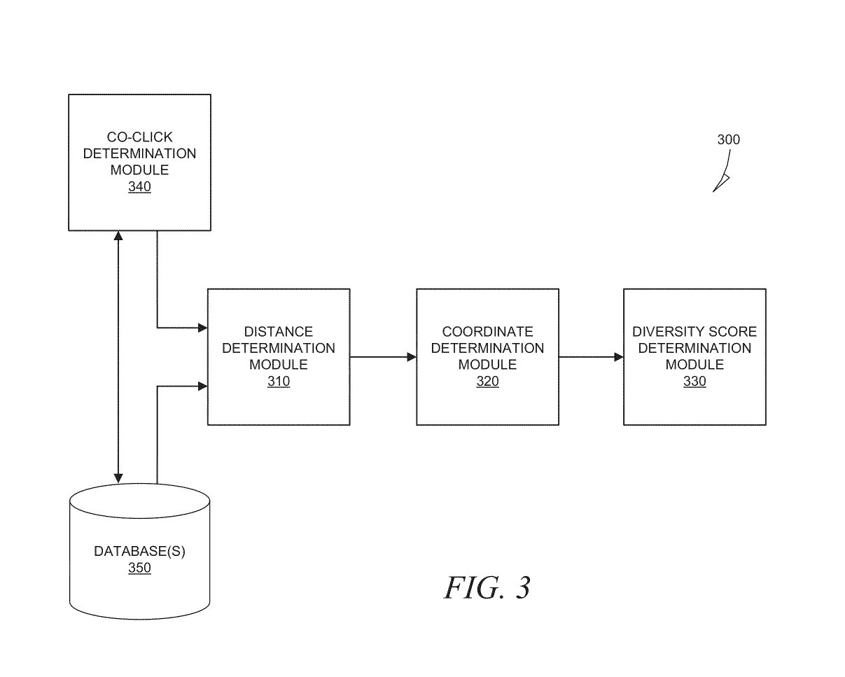

FIG. 3 is a block diagram illustrating an example embodiment of a system 300 that determines the level of diversity for a search query. System 300 comprises a distance determination module 310, a coordinate determination module 320, and a diversity score determination module 330. The distance determination module 310 may be configured to determine, for a query, distances between leaf categories in a hierarchical category tree using co-click information. The coordinate determination module 320 may be configured to determine coordinate representations of the leaf categories using the distances between the leaf categories from the distance determination module 310. The diversity score determination module 330 may be configured to determine a diversity score for the query using the coordinate representations from the coordinate determination module 320. The diversity score can represent a degree of variability in what different users find relevant to the query.

As mentioned above, the distance determination module 310 in FIG. 3 may be configured to determine, for a query, distances between leaf categories in a hierarchical category tree using co-click information. This co-click information may comprise co-click counts between the leaf categories. A co-click count between two leaf categories is the number of times users have clicked, or otherwise selected, at least one search result in each of the two leaf categories during the same search event or session. For example, in the previously discussed example of the query “Fossil,” if during the same search session for the query, a user clicked on an item that belonged to the “Clothing, Shoes and Accessories” category, and also clicked on an item that belonged to the “Dinosaur Fossil” category, that would count as a co-click between those two categories.

Similarity between two leaf categories can be defined using their co-click count. The reasoning behind this approach is that two leaf categories that are co-clicked together very often must be very similar, while two leaf categories with a zero co-click count are considered dissimilar. In some embodiments, clicks that occur in response to the same query in the same search session are considered as co-clicks. Based on the theory that the higher co-click count, the more similar the two leaf categories are, the co-click is indeed a similarity measure. The similarity between leaf categories a, b can be defined as sim

$$( a , b ) = exp ( - \frac{{‖ {x}_{a} - {x}_{b} ‖}^{2}}{{σ}^{2}} ) .$$

From this equation, the distance between leaf categories a, b can be defined as:

$$dist ( a , b ) = - log {\sum }_{i}^{ } {N}_{a}^{( i )} \cdot {N}_{b}^{( i )} + M ,$$

where Nₐ⁽ⁱ⁾, N_{b}⁽ⁱ⁾ denote count of clicks on items from leaf categories a, b in search event i, and M is a positive real number to make distance (a, b) positive.

Different types of bias can exist in how clicks are generated and gathered. One important bias that can be accounted for is impression bias. When items of two different categories are shown together on the same results page, they are more likely to be co-clicked. The more two categories are shown together on the same results page, the higher the impression. A co-impression count between two leaf categories can be defined as the number of times items of the two leaf categories are shown together on the same results page. Since a higher co-impression tends to lead to more co-clicks, the distance determination module 310 can be configured to determine the distances between the leaf categories using a normalization attic co-click counts. This normalization can use co-impression counts between the leaf categories for the query. In some embodiments, a normalized co-click distance between leaf categories a, b can be defined as:

$$dist ( a , b ) = log {\sum }_{i}^{ } {M}_{a}^{( i )} \cdot {M}_{b}^{( i )} - log {\sum }_{i}^{ } {N}_{a}^{( i )} \cdot {N}_{b}^{( i )} ,$$

where Nₐ⁽ⁱ⁾, N_{b}⁽ⁱ⁾ are the number of clicks on items from leaf categories a, b and Mₐ⁽ⁱ⁾, M_{b}⁽ⁱ⁾ denote the number of impressed items from leaf categories a, b in search event i.

The co-click information (e.g., co-click counts or co-impression normalization of the co-click counts) that is used by the distance determination module 310 to determine distances between the leaf categories may be provided to the distance determination module 310 in a variety of ways. Co-click counts and co-impression counts may be stored in one or more databases 350. In some embodiments, the one or more databases 350 may be a part of the one or more databases 126 in FIG. 1. Co-click counts and co-impression counts for a web site can be gathered and/or determined by a co-click determination module 340 and can be stored in one or more databases 350. The co-click determination module 340 can be configured to generate normalized co-click counts using the co-impression counts and then store these normalized co-click counts in the one or more databases 350. These normalized co-click counts in the one or more databases 350 may then be retrieved by the distance determination module 310. In some embodiments, the co-click determination module 340 may retrieve the co-click counts and the co-impression counts from the one or more databases 350, normalize the co-click counts using the co-impression counts, and then provide the normalized co-click counts to the distance determination module 310.

Co-click similarity is a good distance measure between nearby leaf categories (nearby in the sense that users consider them very similar and, as a result, click on them together very frequently). For unrelated categories (e.g., leaf categories in Clothing, Shoes & Accessories and eBay Motors, or Clothing, Shoes, & Accessories and Consumer Electronics), where co-click counts are zero, it can seem difficult to measure distance between them. However, in some embodiments of the present disclosure, it can be assumed that leaf categories lie close to a low-dimensional nonlinear manifold, and geodesic distance along the manifold can be used as an approximate distance measure between non-neighbor leaf categories (e.g., leaf categories with zero co-click counts). In some embodiments, the distance along the manifold can be determined using the shortest hopping distance along the graph. For example, in some embodiments, the distance along the manifold can be determined using Dijkstra's algorithm.

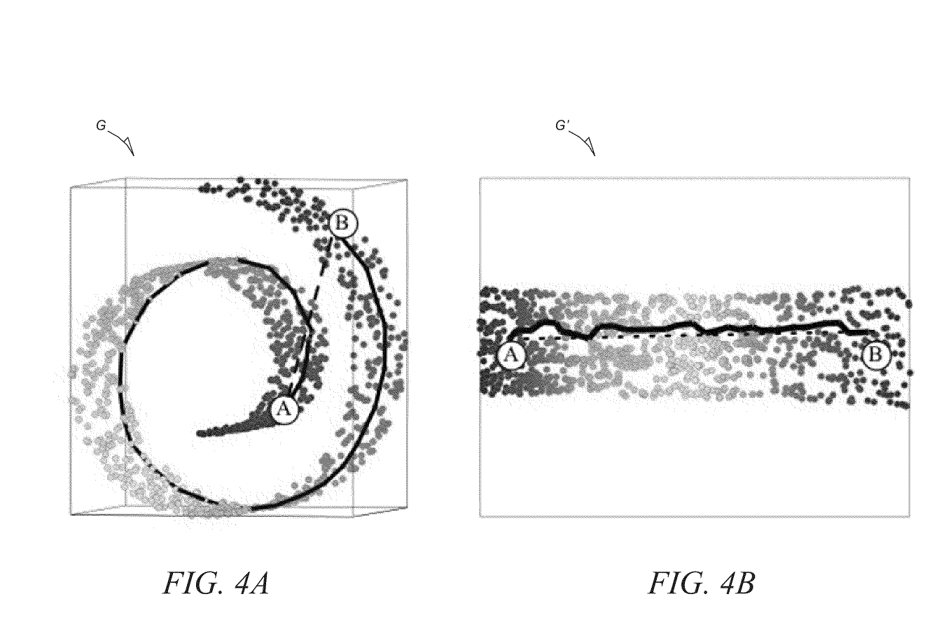

Consider a graph G FIG. 4A, with nodes representing leaf categories (e.g., 18,000 nodes in a U.S. category tree), and edges existing between leaf categories A and B if there are non-zero click counts between A and B. Such a graph will be very sparse, since each leaf category will be co-clicked with only a small number of other leaf categories. In some embodiments, the distance determination module 310 may be configured to determine distances between leaf categories using the following edge weight scheme:
For i, j that are neighbors, G(i, j) is a co-click distance between i, j.
For i, j that are non-neighbors, shortest path distance along the graph, computed via an algorithm (e.g., Dijkstra's algorithm), is used as an approximate geodesic distance between i, j.
   The resulting graph G′ in FIG. 4B is now a dense graph with all entries filled with approximate geodesic distance between any pair A and B.

As mentioned above, the coordinate determination module 320 in FIG. 3 may be configured to determine coordinate representations of the leaf categories using the distances between the leaf categories. In some embodiments, Multi-Dimensional Scaling (MDS) is applied to learn coordinate representations of leaf categories. In some embodiments, MDS takes an N×N matrix of pairwise distances as input, and outputs coordinate representations of leaf nodes that comply with the given pairwise distances. Simply explained, MDS can map leaf categories that are co-clicked often to nearby points, while leaf categories that are never co clicked can be mapped to far-away points in the learned coordinates. In some embodiments, Euclidean distance in the output coordinate is used as a good approximation of the co-click distance.

In some embodiments, a manifold learning algorithm, for example, an Isomap algorithm, may be used to determine coordinate representations of leaf categories. One example of an Isomap algorithm that can be used as the manifold learning algorithm is disclosed in A Global Geometric Framework for Nonlinear Dimensionality Reduction (J. B. Tenenbaum, V. deSilva, and J. C. Langford; Science, 290:2319-2323, 22 Dec. 2000), which is hereby incorporated by reference in its entirety as if set forth herein. In some embodiments, a manifold learning algorithm is implemented by the combination of the distance determination module 310 and the coordinate determination module 320. Unlike linear methods, manifold learning techniques do not make strong global linearity assumption that the input patterns must lie in low-dimensional subspace. Rather, the weak assumption that is made is that the leaf categories lie on or near a low-dimensional nonlinear sub-manifold which describes the structure of the input space. Therefore, in some embodiments, only neighborhood relations are learned (from co-click), and the nonlinear manifold structure is inferred by traversing the neighborhood graph. One embodiment of the steps from the Isomap algorithm are summarized below:
Compute a k-nearest neighbors graph whose vertices represent input patterns and whose edges connect k-nearest neighbors with weight wᵢⱼ.
Compute pairwise distance Δᵢⱼ between all nodes (i, j) along shortest paths through the graph, e.g., using Dijkstra's algorithm.
Pairwise distance Δᵢⱼ from Dijkstra's algorithm are fed to MDS, to learn low dimensional embedding ψᵢε [symbol] ′″, for which ∥ψᵢ−ψⱼ∥²≈Δᵢⱼ². The optimal Ψ is found to be VΛ^{(1/2)}, where V corresponds to the top m eigenvectors corresponding to the m largest eigenvalues of

$$- \frac{1}{2} {J}^{T} {Δ}^{2} J .$$

The computational complexity of the k-nearest neighbor algorithm in densely connected graph is O(n²). However, in the original sparse co-click graph G in FIG. 4A, the complexity is much less, since for most leaf categories, co-click counts will be zero. A Dijkstra's algorithm step to compute approximate geodesic distance can have complexity of O(n² log n), which may be much less with sparse graphs. In the last step, spectral decomposition (eigenvalue-eigenvector decomposition of a dense graph, e.g., G′ in FIG. 49) may be computed to leans the low-dimensional coordinates that best comply with the given pairwise distance matrix. The complexity in this step can be O(n³), where n is the number of nodes in the graph.

As mentioned above, the diversity score determination module 330 in FIG. 3 may be configured to determine a diversity score for the query using the coordinate representations from the coordinate determination module 320. In some embodiments, the coordinate representations form a distribution of leaf categories for a query, and the diversity score of the query may be determined via dispersion analysis. For example, in some embodiments, the mean of the distribution can be computed, and then how far each leaf category is from the mean can be computed, resulting in the diversity score.

In some embodiments, with leaf categories represented as {xᵢ}ᵢ₌₁^{N}ε [symbol] ^{M} (where M is small), a query diversity score may be computed for each query as:

$${diversity}_{q} = \int ‖ x - {\overline{x}}_{q} ‖ {p}_{q} ( x ) d x = {\sum }_{j}^{ } {x}_{j} - {\overline{x}}_{q} ‖ {p}_{q} ( {x}_{j} )$$

$${\overline{x}}_{q} = \int {xp}_{q} ( x ) d x = {\sum }_{j}^{ } {x}_{j} {p}_{q} ( {x}_{j} )$$

where p_{q}(xⱼ) is the click percentage in category xⱼ for query q.

Similar to demand diversity, a supply diversity/dispersion score may be computed as a measure of how diverse a search result page (SRP) is. In some embodiments where p(x) is a leaf category histogram for an SRP, the supply diversity measure can be computed as:

$${diversity}_{SRP} = \int ‖ x - \overline{x} ‖ p ( x ) d x = {\sum }_{j}^{ } ‖ {x}_{j} - \overline{x} ‖ p ( {x}_{j} )$$

$$\overline{x} = \int xp ( x ) d x = {\sum }_{j}^{ } {x}_{j} p ( {x}_{j} )$$

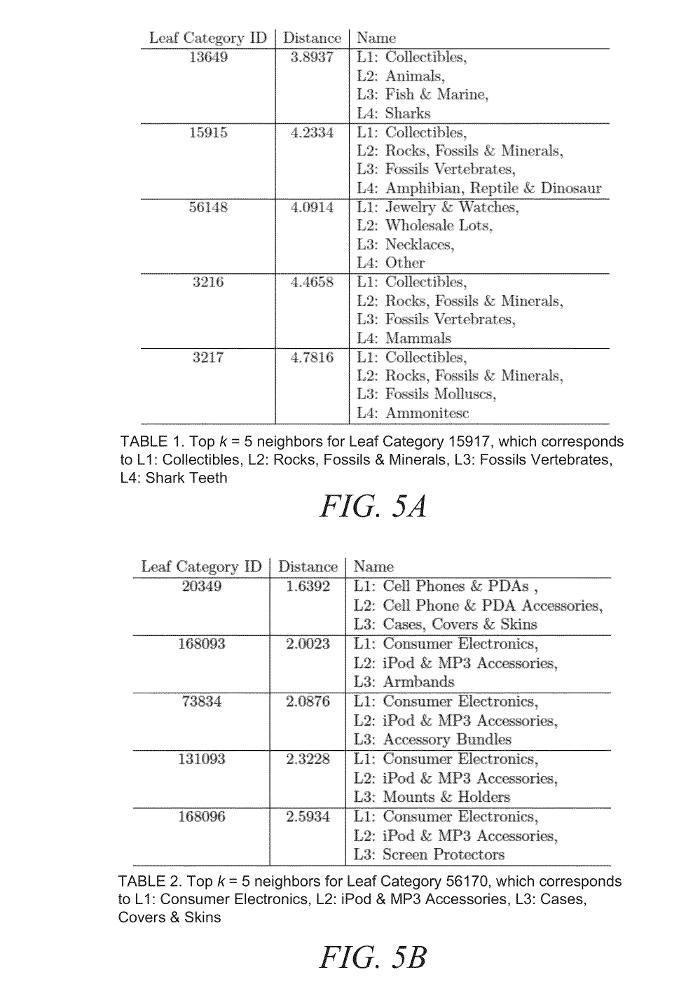

In experimentation with multiple values for k, the number of neighbors, it was found that k=5 yielded optimal performance. Table 1 of FIG. 5A shows an example of the top five neighbors of leaf category 15917. Leaf category 15917 corresponds to first leaf level (L1) for Collectibles, a second leaf level (L2) for Rocks, Fossils & Minerals, a third leaf level (L3) for Fossils Vertebrates, and a fourth leaf level (L4) for Shark Teeth. The top five neighbors for leaf category 15917 are leaf categories 13649, 15915, 56148, 3216, and 3217. Table 1 shows the distances between each of these five neighbors and leaf category 15917, as well as the corresponding leaf levels for each of these neighbors. Table 2 of FIG. 5B shows an example of the top five neighbors of leaf category 56170. Leaf category 56170 corresponds to a first leaf level (L1) for Consumer Electronics, a second leaf level (L2) for iPod & MP3 Accessories, and a third leaf level (L3) for Cases, Covers & Skins. The top five neighbors for leaf category 56170 are leaf categories 20349, 168093, 73834, 131093, and 168096. Table 2 shows the distances between each of these five neighbors and leaf category 56170, as well as the corresponding leaf levels for each of these neighbors.

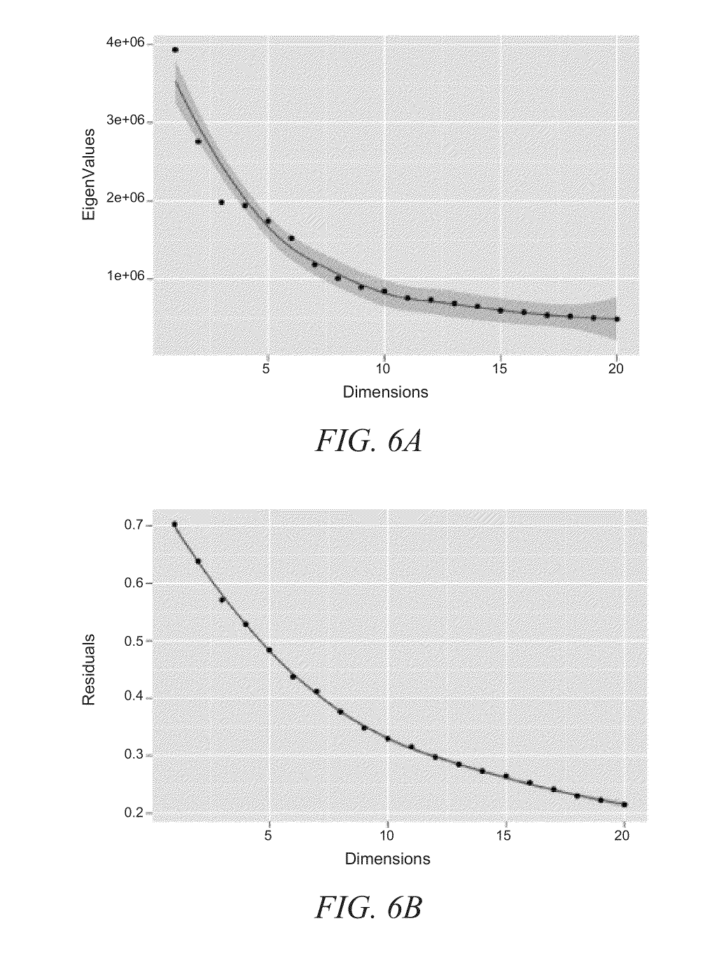

Each leaf category can be represented as a vector in [symbol] ^{M}. The question then becomes how to choose the optimal M, the number of dimensions of the coordinate representation to maintain. As seen in FIGS. 6A-B, M becomes larger, the eigenvalues and the residuals become smaller, and the learned coordinates are able to approximate the geodesic distances learned by Dijkstra's algorithm better. Various methods may be employed to detect eigen gaps to find the optimal value of M.

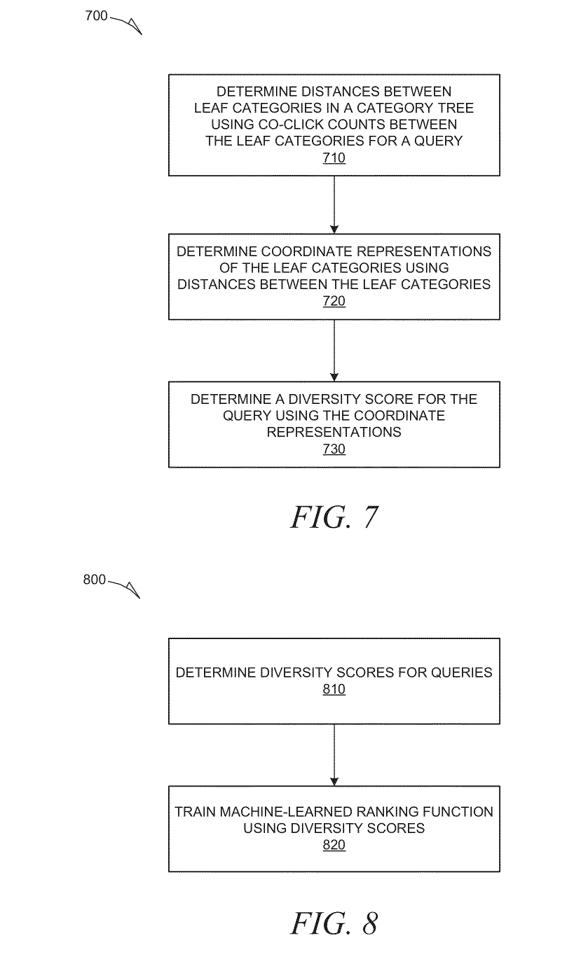

FIG. 7 is a flowchart illustrating an example embodiment of a method 700 for determining the level of diversity for a search query. At operation 710, distances between leaf categories in a hierarchical category tree are determined using co-click counts between the leaf categories for the query. In some embodiments, determining distances between leaf categories comprises determining the distances using a normalization of the co-click counts. In some embodiments, this normalization incorporates co-impression counts between the leaf categories for the query. In some embodiments, the distances are geodesic distances. In some embodiments, determining the distances between leaf categories comprises using Dijkstra's algorithm to determine geodesic distances between leaf categories. At operation 720, coordinate representations of the leaf categories are determined using the distances between the leaf categories. In some embodiments, determining the coordinate representations comprises using a manifold learning algorithm. In some embodiments, determining the coordinate representations comprises using multi-dimensional scaling. At operation 730, a diversity score for the query is determined using the coordinate representations. In some embodiments, determining the diversity score comprises performing a dispersion analysis on the coordinate representations.

FIG. 8 is a flowchart illustrating an example embodiment of a method 800 for training a machine-learned ranking model. At operation 810, diversity scores are determined for different search queries. In some, embodiments, the diversity scores are determined using any combination of the methods described above. At operation 820, a machine-learned ranking function is trained using the diversity scores. In some embodiments, this machine-learned ranking function is used by a web site to rank search results. In some embodiments, the diversity scores can also be used to design or update a category tree.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware e.g., machine) and software architectures that may be deployed, in various example embodiments.

### Example Machine Architecture and Machine-Readable Medium

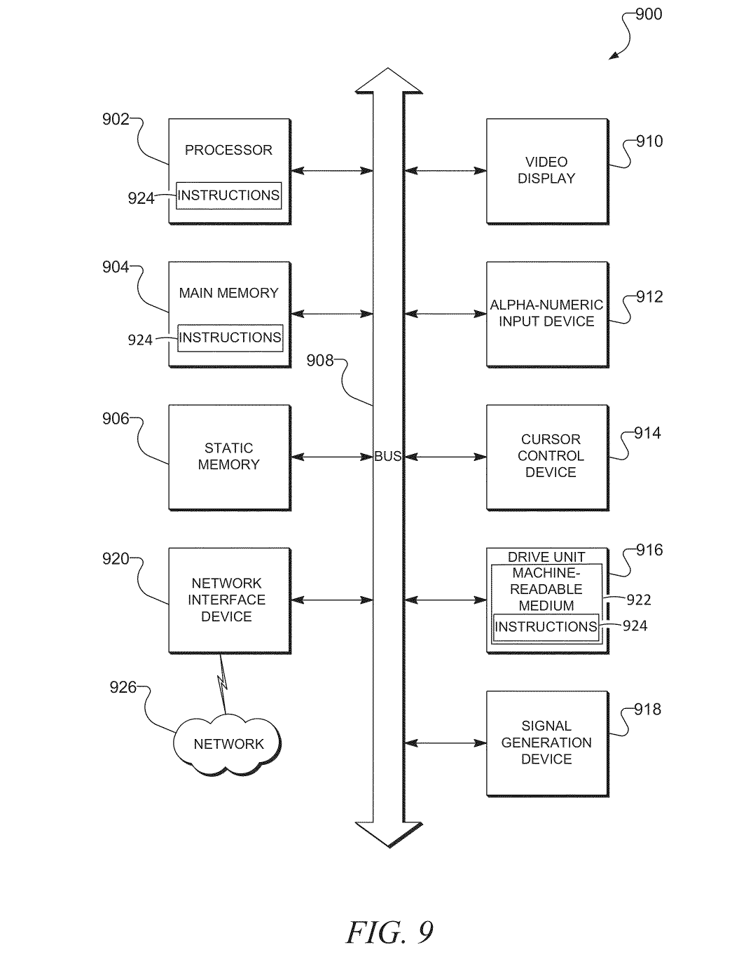

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media. The instructions 924 may also reside, completely or at least partially, within the static memory 906.

White the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “machine-readable medium” shalt also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor;
a distance determination module, executable by the at least one processor, configured to determine distances between leaf categories in a hierarchical category tree using co-click counts between the leaf categories for a query;
a coordinate determination module, executable by the at least one processor, configured to determine coordinate representations of the leaf categories using the distances between the leaf categories; and
a diversity score determination module, executable by the at least one processor, configured to determine a diversity score for the query using the coordinate representations, the diversity score representing a degree of variability in what different users find relevant to the query.

2. The system of claim 1, wherein the distance determination module is configured to determine the distances between the leaf categories using a normalization of the co-click counts that uses co-impression counts between the leaf categories for the query.

3. The system of claim 1, wherein the coordinate determination module is configured to determine the coordinate representations using a manifold learning algorithm.

4. The system of claim 1, wherein the distances are geodesic distances.

5. The system of claim 4, wherein the distance determination module is configured to use Dijkstra's algorithm to determine geodesic distances between leaf categories.

6. The system of claim 1, wherein the coordinate determination module is configured to determine the coordinate representations using multi-dimensional scaling.

7. The system of claim 1, wherein the diversity score determination module is configured to determine the diversity score using dispersion analysis of the coordinate representations.

8. A computer-implemented method comprising:
determining distances between leaf categories in a hierarchical category tree using co-click counts between the leaf categories for a query;
determining coordinate representations of the leaf categories using the distances between the leaf categories; and
determining a diversity score for the query using the coordinate representations, the diversity score representing a degree of variability in what different users find relevant to the query.

9. The method of claim 8, wherein the step of determining distances between leaf categories comprises determining the distances using a normalization of the co-click counts that uses co-impression counts between the leaf categories for the query.

10. The method of claim 8, wherein the step of determining the coordinate representations comprises using a manifold learning algorithm.

11. The method of claim 8, wherein the distances are geodesic distances.

12. The method of claim 11, wherein the step of determining the distances between leaf categories comprises using Dijkstra's algorithm to determine geodesic distances between leaf categories.

13. The method of claim 8, wherein the step of determining the coordinate representations comprises using multi-dimensional scaling.

14. The method of claim 8, wherein the step of determining the diversity score comprises using dispersion analysis of the coordinate representations.

15. A non-transitory machine-readable storage device storing a set of instructions that, when executed by at least one processor, causes the at least one processor to perform operations comprising:
determining distances between leaf categories in a hierarchical category tree using co-click counts between the leaf categories for a query;
determining coordinate representations of the leaf categories using the distances between the leaf categories; and
determining a diversity score for the query using the coordinate representations, the diversity score representing a degree of variability in what different users find relevant to the query.

16. The machine-readable storage device of claim 15, wherein the operation of determining distances between leaf categories comprises determining the distances using a normalization of the co-click counts that uses co-impression counts between the leaf categories for the query.

17. The machine-readable storage device of claim 15, wherein the operation of determining the coordinate representations comprises using a manifold learning algorithm.

18. The machine-readable storage device of claim 15, wherein the distances are geodesic distances.

19. The machine-readable storage device of claim 18, wherein the operation of determining the distances between leaf categories comprises using Dijkstra's algorithm to determine geodesic distances between leaf categories.

20. The machine-readable storage device of claim 15, wherein the operation of determining the coordinate representations comprises using multi-dimensional scaling.

21. The machine-readable storage device of claim 15, wherein the operation of determining the diversity score comprises using dispersion analysis of the coordinate representations.
